(19) United States
(12) Patent Application Publication
(10) Pub. No.: US 2011/0296519 A1
(43) Pub. Date: Dec. 1, 2011

(54) REPUTATION BASED CONNECTION CONTROL

(75) Inventors: Curtis Ide, Roswell, GA (US); Sven Krasser, Atlanta, GA (US); Dmitri Alperovitch, Atlanta, GA (US)

(73) Assignee: MCAFEE, INC., Santa Clara, CA (US)

(21) Appl. No.: 13/108,493

(22) Filed: May 16, 2011

Related U.S. Application Data
(60) Provisional application No. 61/334,811, filed on May 14, 2010.

(51) Int. Cl. G06F 21/20

(52) U.S. Cl. 726/13

(57) ABSTRACT

Methods and systems for operation upon one or more data processors for reputation based firewall processing of communications. The reputation based firewall processing includes receiving a communication identifying an entity, retrieving the reputation of the entity identified by the communication, and handling the communication based upon the retrieved reputation.

### CROSS-REFERENCE TO RELATED APPLICATIONS

This application claims priority under 35 U.S.C. §119(e) to U.S. Provisional Application Ser. No. 61/334,811 titled “Reputation Based Connection Control” filed May 14, 2010, the disclosure of which is incorporated herein by reference in its entirety.

### TECHNICAL FIELD

This document relates to systems and methods for processing communications.

### BACKGROUND

Increased reliance on electronic communications by many individuals and companies has led to increasing number of targets for malicious users. Many application layer technologies exist for identifying unwanted communications to/from the network. However, increasing sophistication among malicious users can make it difficult to accurately identify malicious communications. Moreover, many of the application layer technologies allow the malicious users to create a connection with network, thereby potentially enabling malicious users to exploit an initial connection to the network. Further, these application layer technologies can be difficult to keep up to date with new attacks being identified daily.

### SUMMARY

In general, one aspect of the subject matter described in this specification can be embodied in methods that include receiving a communication at a data processing apparatus; parsing, at the data processing apparatus, the communication to identify entities associated with the communication; retrieving, at the data processing apparatus, reputation information for the entities; applying, at the data processing apparatus, a firewall policy to the communication based upon the retrieved reputation information associated with the entities; and processing, at the data processing apparatus, the communication responsive to applying the firewall policy. Other embodiments of this aspect include corresponding systems, apparatus, and computer program products.

The details of one or more embodiments of the subject matter described in this specification are set forth in the accompanying drawings and the description below. Other features, aspects, and advantages of the subject matter will become apparent from the description, the drawings, and the claims.

### DESCRIPTION OF DRAWINGS

FIG. 1 is a block diagram depicting an example network environment including a reputation based firewall system.

FIG. 2 is a block diagram illustrating an example network architecture including multiple reputation engines coupled to a network.

FIG. 3 is a block diagram depicting an example of communications and entities including identifiers and attributes used to detect relationships between entities.

FIG. 4 is a block diagram illustrating a determination of a global reputation based on local reputation feedback.

FIGS. 5A-C are block diagrams illustrating reputation based firewall systems.

FIG. 6 is a flowchart illustrating an example method for reputation based firewall processing.

FIG. 7 is a flowchart illustrating an example method for reputation based firewall processing.

FIG. 8 is a block diagram illustrating operation of reputation based firewall systems.

### DETAILED DESCRIPTION

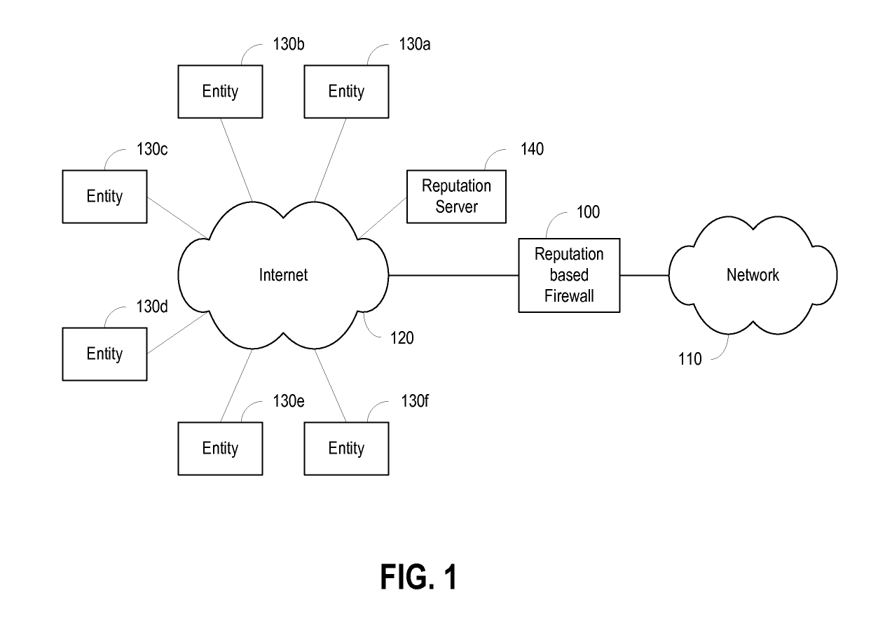

FIG. 1 is a block diagram depicting an example network environment including an example reputation based firewall system 100. A reputation based firewall system 100 can reside between an internal network 110 (e.g., an enterprise network) and an external network 120. The network 110 can include a number of servers, including, for example, electronic mail servers, web servers, and various application servers as may be used by the enterprise associated with the network 110.

Reputation information can be derived from numerous electronic messages identified by reputation engines placed at various connection points to the network. In some implementations, the reputation information can be collected and aggregated. The reputation information can be distributed to the firewall system 100. In some implementations, the reputation information can provide context to an entity's reputation to enable the firewall system 100 to intelligently deny, reroute, or quarantine traffic.

The reputation based firewall system 100 monitors communications entering and exiting the network 110. These communications can be received through the Internet 120 from any entities 130a-f connected to the Internet 120. One or more of the entities 130a-f can be legitimate originators of communications traffic, i.e., reputable entities. However, other of the entities 130a-f can be non-reputable entities originating unwanted communications.

The reputation based firewall system 100 is coupled to, i.e., in data communication with, a reputation server 140. The reputation server can include a reputation engine operable to derive reputation information associated with entities. Example reputation engines and derivation of reputation information are described in detail in United States Patent Publication No. 2006/0015942, which is hereby incorporated by reference in its entirety.

In some implementations, the reputation based firewall system 100 can periodically retrieve reputation information for at least a portion of entities from the reputation server 140. In other implementations, the reputation based firewall system 100 can retrieve reputation information for a particular entity from the reputation server 140 in response to receiving a communication from that entity. In still further implementations, the reputation server 140 can periodically push updated reputation information to the reputation based firewall system 100. In other implementations, the reputation server 140 pushes only reputation information that has been changed since a previous update was applied.

In some implementations, the reputation information or updated reputation information sent from the reputation server 140 to the reputation based firewall system 100 can be authenticated by the reputation based firewall system 100 prior to applying the reputation information or updated reputation information. For example, the reputation server 140 can encrypt the reputation information using a key known only to the reputation based firewall system 100. In other examples, the reputation server can apply any function known to the reputation server 140 and the reputation based firewall system 100 to identifying information for one or both of the reputation server 140 and the reputation based firewall system 100.

The reputation based firewall system 100 can parse the communication to identify entities 130 that are associated with the communication. Upon identifying the entities associated with the communication, the reputation based firewall system 100 can query the reputation of the identified entities. In those implementations where reputation information is stored locally, the query can be communicated to a local reputation store. In those implementations where reputation information is stored remotely, the query can be directed to a reputation server 140. The reputation server 140 (or local reputation store) can provide reputation information for use by the firewall system 100.

The firewall can execute a policy to determine whether to allow the communication. The policy can include one or more rules identifying when to allow a communication and/or when to reject a communication. In some implementations of reputation based firewall system 100, the rules can be based upon the reputation(s) of the entity(ies) sending the communication. For example, the rules can be set to cause the firewall system 100 to reject communications associated with entities that have a reputation for originating viruses. In some implementations, the strength of the reputation for various types of activity can be used to determine whether to reject or delay delivery of a communication. For example, a policy might allow communications associated with entities that have a low correlation to originating spam activity, while rejecting or delaying delivery of a communication associated with an entity that has reputation indicating a high correlation to spam activity.

In other implementations, a reputation engine can be included in the reputation based firewall system 100. In such implementations, the reputation engine can track and derive reputations associated with entities identified from communications received by the reputation based firewall system 100. The reputation engine can parse the communication to identify one or more entities associated with the communication. A reputation associated with the one or more entities can then be retrieved and provided to a firewall for determination of how to handle the communication based upon policy. In some implementations, the reputation engine can derive the reputation of the entity offline (e.g., prior to receipt of a query for the entity's reputation). In other implementations, the reputation engine can derive the reputation of the entity in real-time, thereby providing the most current reputation information every time reputation information associated with an entity is requested.

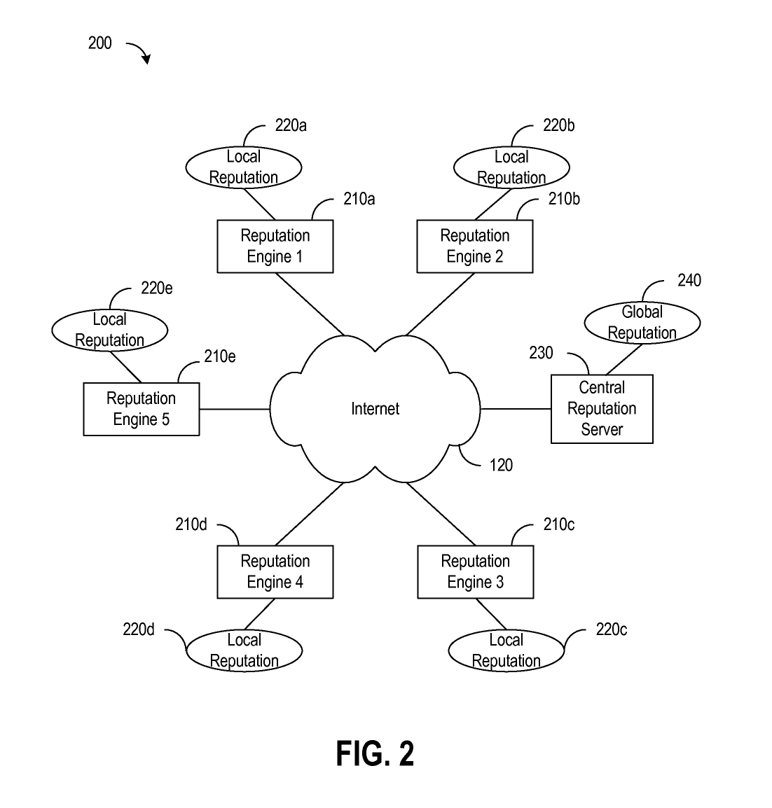

FIG. 2 is a block diagram illustrating an example network architecture 200 including multiple reputation engines 210a-e coupled to a network 120. The reputation engines 210a-e can include local reputations 220a-e derived by the local reputation engines 210a-e. The network architecture 200 can also include one or more central reputation servers 230 storing a global reputation 240. In some implementations, the local reputation engines 210a-e, for example, can be associated with local security agents (e.g., including reputation based firewall systems 100). The reputation engines 210a-e can include a list of one or more entities for which the reputation engine 210a-e stores a derived reputation 220a-e.

In various examples, the derived reputations 220a-e might be inconsistent between reputation engines 210a-e. For example, because reputation engines distributed within a network may observe different types of traffic based upon their location (e.g., physical or logical location), each reputation system may observe different behavior characteristics associated with entities tracked by the respective reputation engine 210a-e. For example, reputation engine 1 210a might include a reputation information that indicates a particular entity is reputable, while reputation engine 2 210b may include a reputation information that indicates that the same entity is non-reputable. Such local reputation inconsistencies can be based upon different traffic received from the entity. Alternatively, the inconsistencies can be based upon the feedback from a user of local reputation engine 1 210a indicating a communication is legitimate, while a user of local reputation engine 2 210b provides feedback indicating that the same communication is not legitimate.

In some implementations, the central reputation server 230 can receive reputation information 220a-e from the local reputation engines 210a-e. However, as noted above, some of the local reputation information may be inconsistent with other local reputation information. The central reputation server 230 can arbitrate between the local reputations 220a-e to determine a global reputation 240 based upon the local reputation information 220a-e. In some examples, the global reputation information 240 can be provided to security agents (e.g., including reputation based firewall systems 100 of FIG. 1) to provide the security agents with up-to-date reputation information. Alternatively, security agents can be operable to query the server 230 for reputation information. In some examples, the central reputation server 230 can respond to the query with global reputation information 240.

In some implementations, the central reputation server 230 can apply a local reputation bias to the global reputation 240. The local reputation bias can transform the global reputation 240 to provide security agents with a global reputation vector that is biased based upon the preferences of the particular local reputation engine 210a-e that originated the query. Thus, a local reputation engine 210a with an administrator or user(s) that has indicated a high tolerance for spam messages can receive a global reputation vector that accounts for an indicated tolerance. The particular components of the reputation vector returned to the reputation engine 210a can include portions of the reputation vector that are deemphasized with respect to the rest of the reputation vector. Likewise, a local reputation engine 210b that has indicated, for example, a low tolerance for communications from entities with reputations for originating viruses might receive a reputation vector that amplifies the components of the reputation vector that relate to virus reputation.

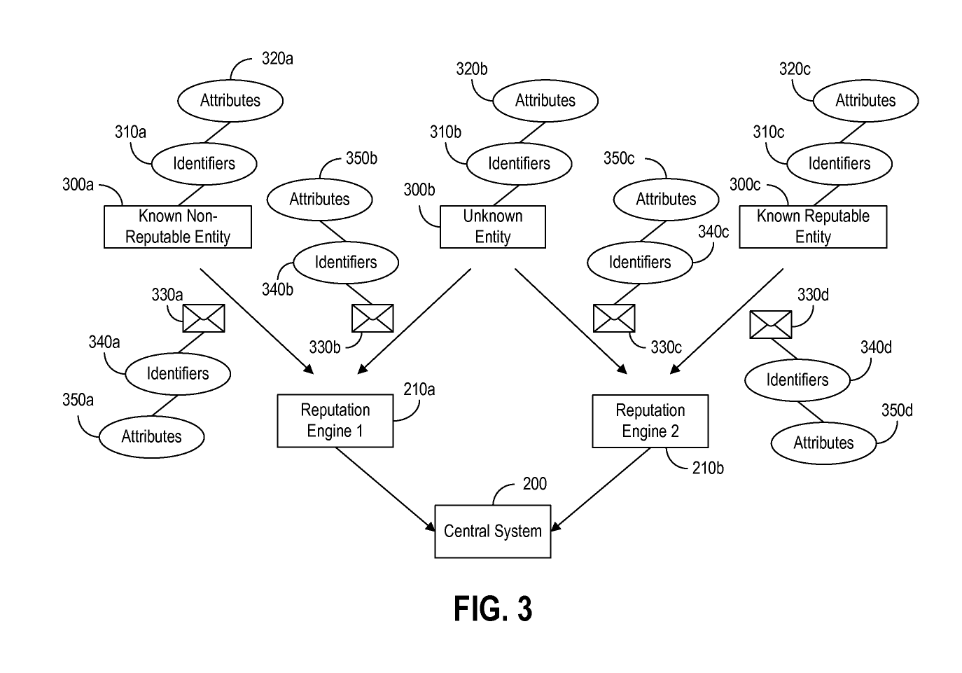

FIG. 3 is a block diagram depicting an example of communications and entities including identifiers and attributes used to detect relationships between entities. Reputation engines 210a-b can collect data by examining communications that are directed to an associated network. Reputation engines 210a-b can also collect data by examining communications that are relayed by an associated network. Examination and analysis of communications can allow the reputation engines 210a-b to collect information about the entities 300a-c sending and receiving messages, including transmission patterns, volume, or whether the entity has a tendency to send certain kinds of message (e.g., legitimate messages, spam, virus, bulk mail, etc.), among many others.

As shown in FIG. 3, each of the entities 300a-c is associated with one or more identifiers 310a-c, respectively. The identifiers 310a-c can include, for example, Internet protocol (IP) addresses, universal resource locator (URL), phone number, IM username, message content, domain, or any other identifier that might describe an entity. Moreover, the identifiers 310a-c are associated with one or more attributes 320a-c. In various implementations, the attributes 320a-c can correspond to the particular identifier 310a-c that is being described. For example, a message content identifier could include attributes such as, for example, malware, volume, type of content, behavior, etc. Similarly, attributes 320a-c associated with an identifier, such as IP address, could include one or more IP addresses associated with an entity 300a-c.

In some implementations, the identifiers and attributes can be collected from communications 330a-c (e.g., e-mail, web traffic, instant messaging, voice over Internet protocol (VoIP), data packets, etc.). These communications include data defining the identifiers and attributes of the entity that originated the communication. Thus, the communications 330a-c provide a transport for communicating information about the entity to the reputation engines 210a-b. In some implementations, the attributes of a communication can be detected by the reputation engines 210a-b through examination of the overhead (e.g., header) information included in the message, analysis of the content of the message, as well as through aggregation of information previously collected by the reputation engines 210a-b (e.g., totaling the volume of communications received from an entity, identifying a rate of communication over a time period, etc.).

In some implementations, the data collected by multiple reputation engines 210a-b can be aggregated and mined by a central system 202, e.g., a central reputation server. For example, the central reputation server 202 can receive identifiers and attributes associated with all entities 300a-c for which the reputation engines 210a-b have received communications. Alternatively, the reputation engines 210a-b can operate as a distributed system, communicating identifier and attribute information about entities 300a-c with each other. The process of mining the data can correlate the attributes of entities 300a-c with each other, thereby identifying relationships between entities 300a-c (such as, for example, correlations between an event occurrence, volume, and/or other determining factors).

These relationships can then be used to establish a multi-dimensional reputation “vector” for all identifiers based on the correlation of attributes that have been associated with each identifier. For example, if a non-reputable entity 300a with a known reputation for being non-reputable sends a message 330a with a first set of attributes 350a, and then an unknown entity 300b sends a message 330b with a second set of attributes 350b, the reputation engine 210a can determine whether all or a portion of the first set of attributes 350a match all or a portion of the second set of attributes 350b. When some portion of the first set of attributes 350a matches some portion of the second set of attributes 350b, a relationship can be created depending upon the particular identifier 320a, 320b that included the matching attributes 350, 350b. The particular identifiers 340a, 340b that are found to have matching attributes can be used to determine a strength associated with the relationship between the entities 300a, 300b. The strength of the relationship can be used to determine how much of the non-reputable qualities of the non-reputable entity 300a are attributed to the reputation of the unknown entity 300b. In other examples, communications between a known non-reputable entity 300a and an unknown entity 300b can be used to identify a relationship between the known non-reputable entity 300a and the unknown entity 300b. A volume of communications between the entities can be used to identify a strength of the relationship between the non-reputable entity 300a and the unknown entity 300b.

In other instances, the unknown entity 300b may originate a communication 330c which includes attributes 350c that match some attributes 350d of a communication 330d originating from a known reputable entity 300c. The particular identifiers 340c, 340d that are found to have matching attributes can be used to determine a strength associated with the relationship between the entities 300b, 300c. The strength of the relationship can be used to determine how much of the reputable qualities of reputable entity 300c are attributed to the reputation of the unknown entity 300b.

In some implementations, a distributed reputation engine can facilitate real-time collaborative sharing of global intelligence about the latest threat landscape, providing instant protection benefits to the local analysis that can be performed by a filtering or risk analysis system, as well as identify malicious sources of potential new threats before they even occur. Using sensors positioned at many different geographical locations information about new threats can be quickly and shared with the central system 200, or with the distributed reputation engines 210a, 100b. Such distributed sensors can include the local reputation engines 210a, 100b, as well as local reputation clients, traffic monitors, or any other device suitable for collecting communication data (e.g., switches, routers, servers, firewalls, etc.).

In some implementations, reputation engines 210a-b can communicate with the central system 202 to provide sharing of threat and reputation information. In other implementations, the reputation engines 210a-b can communicate threat and reputation information amongst each other to provide up to date and accurate threat information. In the example of FIG. 3, the first reputation engine 210a has information about the relationship between the unknown entity 300b and the non-reputable entity 300a, while the second reputation engine 210a has information about the relationship between the unknown entity 300b and the reputable entity 300c. Without sharing the information, the first reputation engine 210a may take a particular action on the communication based upon the detected relationship between non-reputable entity 300a and the unknown entity 300b. However, with the knowledge of the relationship between the unknown entity 300b and the reputable entity 300c, the second reputation engine 210b might take a different action with a received communication associated with the unknown entity 300b. Sharing of the relationship information between reputation engines, thus provides for a more complete set of relationship information upon which a determination will be made.

Reputations reflecting a general disposition and/or categorization are assigned to physical entities, such as individuals or automated systems performing transactions. In the virtual world, entities can be represented by identifiers (e.g., IPs, URLs, content) that are tied to those entities in the specific transactions (such as sending a message or transferring money out of a bank account) that the entities are performing. Reputation can thus be assigned to those identifiers based on their overall behavioral and historical patterns as well as their relationship to other identifiers, such as the relationship of IPs sending messages and URLs included in those messages. A “bad” reputation for a single identifier can cause the reputation of other neighboring identifiers to worsen if there is a strong correlation between the identifiers. For example, an IP address that is sending URLs, which have a bad reputation, will worsen its own reputation because of the reputation of the URLs. In some implementations, individual identifier reputations can be aggregated into a single reputation score for the entity that is associated with those identifiers.

In various implementations, detected attributes can fall into a number of categories. For example, evidentiary attributes can represent physical, digital, or digitized physical data about an entity. This data can be attributed to a single known or unknown entity, or shared between multiple entities (forming entity relationships). Examples of evidentiary attributes relevant to messaging security can include IP (Internet protocol) address, known domain names, URLs, digital fingerprints or signatures used by the entity, and TCP signatures, among many others.

As another example, behavioral attributes can represent human or machine-assigned observations about either an entity or an evidentiary attribute. Such attributes may include one, many, or all attributes from one or more behavioral profiles. For example, a behavioral attribute generically associated with a spammer may be a high volume of communications being sent from that entity.

A number of behavioral attributes for a particular type of behavior can be combined to identify a behavioral profile. A behavioral profile can contain a set of predefined behavioral attributes. The attributive properties assigned to these profiles include behavioral events relevant to defining the disposition of an entity matching the profile. Examples of behavioral profiles relevant to messaging security might include, “Spammer”, “Scammer”, and “Legitimate Sender,” among many others. Events and/or evidentiary attributes relevant to each profile define appropriate entities to which a profile should be assigned. This may include a specific set of sending patterns, blacklist events, or specific attributes of the evidentiary data. Some examples include: sender/receiver identification; time interval and sending patterns; severity and disposition of payload; message construction; message quality; protocols and related signatures; communications medium

Entities sharing some or all of the same evidentiary attributes have an evidentiary relationship. Similarly, entities sharing behavioral attributes have a behavioral relationship. These relationships help form logical groups of related profiles, which can then be applied adaptively to enhance the profile or identify entities slightly more or less standard with the profiles assigned.

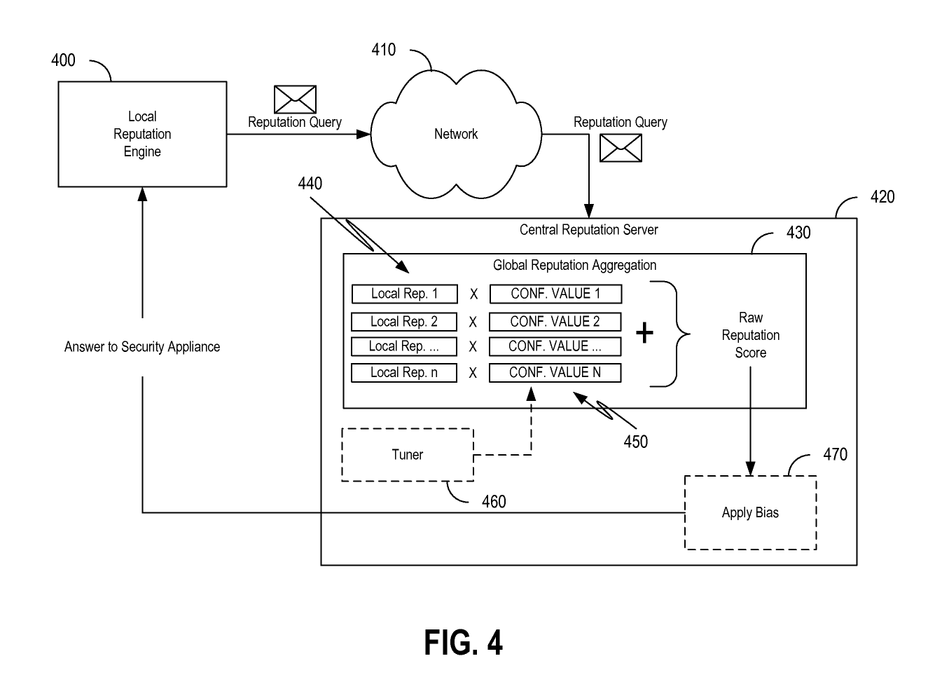

FIG. 4 is a block diagram illustrating a determination of a global reputation based on local reputation feedback (e.g., from a client system or a firewall system). In some implementations, a local reputation engine 400 can send a query through a network 410 to a central reputation server 420. The local reputation engine 400 originates the query in response to receiving a communication from an unknown entity. Alternatively, the local reputation engine 400 can originate the query responsive to receiving any communications, thereby promoting use of reputation information collected from a variety of sources and potentially more recent data indicative of the reputation of the entity.

The server 420 is operable to respond to the query with a global reputation determination. The central reputation server 420 can derive the global reputation using a global reputation aggregation engine 430. The global reputation aggregation engine 430 can receive a plurality of local reputations 440 from a respective plurality of local reputation engines (e.g., reputation engine 210a-e of FIG. 2). In some examples, the plurality of local reputations 440 can be periodically sent by the reputation engines to the server 420. Alternatively, the plurality of local reputations 440 can be retrieved by the server upon receiving a query from one of the local reputation engines 400.

In some implementations, the local reputations can be combined using confidence values 450 related to each of the local reputation engines and then accumulating the results. The confidence value 450 can indicate the confidence associated with a local reputation produced by an associated reputation engine. For example, reputation engines associated with small networks or a small amount of traffic may be assigned a lower weighting in the global reputation determination. In contrast, local reputations associated with reputation engines operating on large networks might be assigned greater weight in the global reputation determination based upon the confidence value associated with that reputation engine.

In some implementations, the confidence values 450 can be based upon feedback received from users. For example, a reputation engine that receives feedback indicating that communications were not properly handled may be assigned a low confidence score. Thus, because local reputation information 440 associated with the communication consistently misclassifies messages based on the reputation information, the reputation engine can be assigned low confidence values 450 for local reputations 440 produced by those reputation engines. Similarly, reputation engines that consistently receive feedback indicating that the communications were handled correctly based upon local reputation information 440 associated with the communication can be assigned a high confidence value 450 for local reputations 440 associated with the reputation engine.

In some implementations, the confidence values associated with the various reputation engines can be adjusted using a tuner 460. The tuner 460 can receive input information and to adjust the confidence values based upon the received input. The input can be feedback from users, input from administrators, or third party reputation information, among others.

In some implementations, the confidence values 450 can be provided to the central reputation server 420 by the reputation engine. For example, the reputation engine 400 can store statistics for feedback received from users. The confidence values 450 can then be provided to the central reputation server 420 based upon stored statistics for incorrectly classified entities or correctly classified entities. In other implementations, information used to weight the local reputation information can be communicated to the server 420.

In some implementations, a bias 470 can be applied to the resulting global reputation vector. The bias 470 can normalize the reputation vector to provide a normalized global reputation vector to a reputation engine 400. Alternatively, the bias 470 can be applied to account for local preferences associated with the reputation engine 400 originating the reputation query. Thus, a reputation engine 400 can receive a global reputation vector from the central reputation server 420 that matches the defined preferences of the querying reputation engine 400. The reputation engine 400 can take an action on the communication based upon the global reputation vector received from the central reputation server 420.

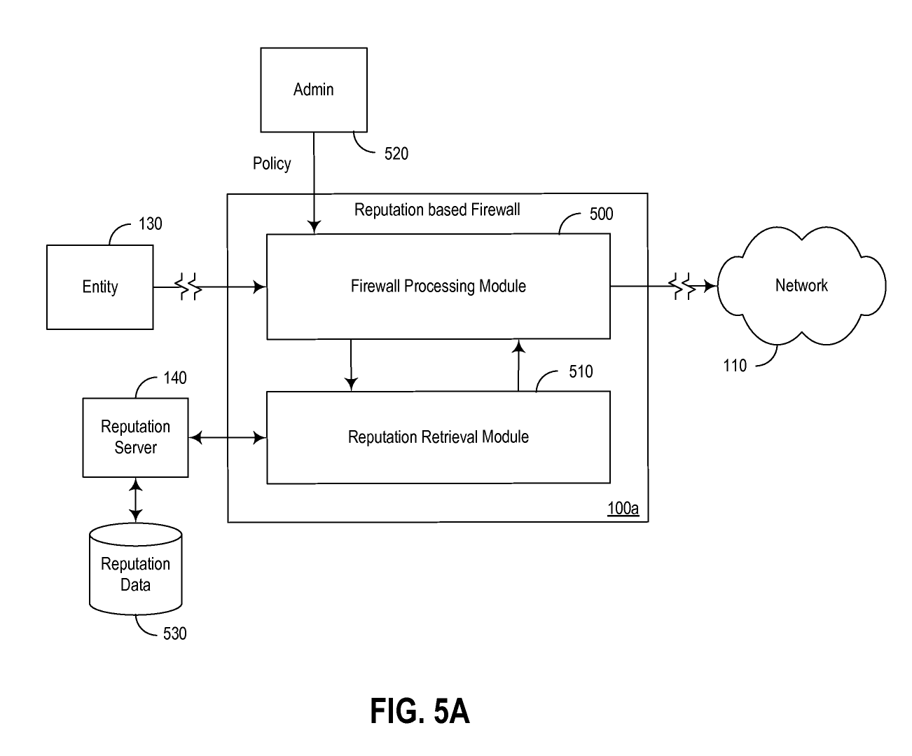

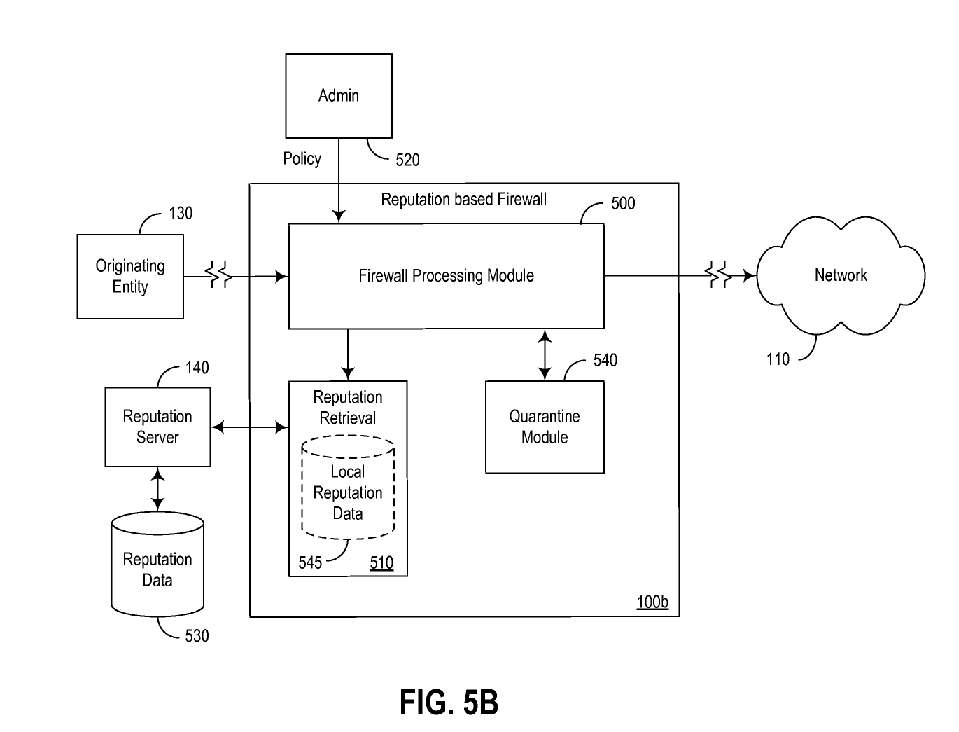

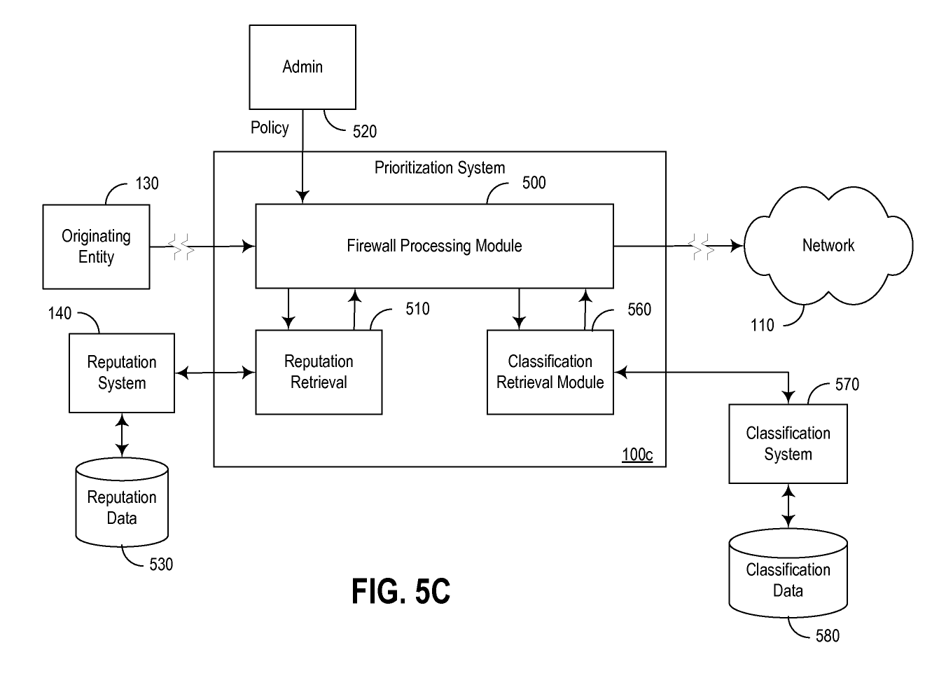

FIGS. 5A is a block diagram illustrating an example reputation based firewall system 100a. In some implementations, the reputation based firewall system 100a can include a firewall processing module 500 and a reputation retrieval module 510. The firewall processing module 500 can provide standard firewall processing in addition to providing reputation based processing.

In some implementations, the firewall processing module 500 can receive policy from an administrator 520. The policy provided can indicate which connections requests are allowable and which should be rejected. In some implementations, the policy can be based upon reputation information. For example, the administrator 520 might specify that the reputation based firewall system 100a should reject connection requests from entities 130 associated with originating viruses.

In some implementations, the policy specified by the administrator 520 can be context dependent. For example, the policy can indicate to reject incoming hypertext transfer protocol (HTTP) packets when an entity 130 associated with the packets has a reputation associated with phishing activity. In such an example, the firewall might allow electronic mail communications while rejecting communications associated with the entity 130.

In some implementations, the firewall processing module 500 can include stateful communication processing logic, i.e., logic that determines if a communication is part of one or more communications in a previously approved state, such as a data packet that is part of a message that has been determined to be reputable. The stateful communication logic avoids the retrieval of reputation information for communications associated with previously connected sessions. Such stateful processing of communications can enable deeper inspection of new connection requests by freeing processing resources, and avoid delaying communications associated with preexisting sessions while the reputation information is retrieved.

The firewall processing module 500 can request reputation information from the reputation retrieval module 510 in response to receiving a communication or connection request. The reputation retrieval module 510 can query a reputation server 140 to retrieve reputation information associated with the communication. In some implementations, the query can include identification of entities associated with the communication or connection request. The reputation retrieval module 510 can parse the communication to identify the entities associated with the communication. In other implementations, the query can include the communication or connection request itself. In such implementations, the reputation server 140 can parse the communication or connection request to identify the entities associated with the communication.

The reputation server 140 can locate the reputation information associated with the communications from a reputation store 530. In some implementations, the reputation store is keyed by an entity identifier. Thus, the reputation information can be retrieved from the reputation store 530 based upon identification of the entity. For example, if an entity corresponds to an IP address, the reputation server 140 can query the reputation store 530 for records associated with the specified IP address. The reputation server 140 can provide the retrieved reputation information back to the reputation retrieval module 510. In some examples, the reputation information includes the reputation vector for each of the entities associated with the communication.

In some implementations, the reputation retrieval module 510 can apply preferences to the retrieved reputation information. For example, the preferences can be applied by performing a biasing operation on reputation vectors associated with entities. The biasing operation can cause various of the characteristics of the reputation vector to be emphasized (e.g., if the policy is intolerant to the associated activity) or deemphasized (e.g., if the policy is lenient to the associated activity). In other implementations, the reputation information can be provided directly to the firewall processing module 500, without application of any preferences to the reputation information. The firewall processing module 500 can apply policy to the reputation information to determine whether to allow the communication. If the communication complies with policy, the communication is forwarded to the network. If the communication does not comply with policy, the communication can be quarantined, dropped, delayed, rejected, etc.

In some implementations, the reputation information can be authenticated prior to determining how to handle the communication or connection request. For example, the reputation server 140 might encrypt at least a portion of a communication including the reputation information. In some examples, a random number can be encrypted by the reputation retrieval module 210 and communicated to the reputation (e.g., using a public encryption key associated with the reputation server 140). The reputation server 140 can decrypt the random number (e.g., using its private encryption key). The reputation server 140 can reencrypt the random number using the public encryption key of the reputation based firewall system 100a. The reputation retrieval module 510 can then decrypt the random number and authenticate the reputation information based upon the encrypted random number received from the reputation server 140 matching the random number originated by the reputation retrieval module 510 when the reputation information was requested from the reputation server 140.

FIGS. 5B is a block diagram illustrating another example reputation based firewall system 100b. In some implementations, the reputation based firewall system 100b can include a firewall processing module 500, a reputation retrieval module 510, and a quarantine module 540. The firewall processing module 500 can process incoming communications to determine whether to allow the communications, or whether to reject the communications or store the communications into the quarantine module 540.

In some implementations, the firewall processing module 500 can provide stateful processing of incoming communications. In such implementations, communications associated with sessions that were previously established are not inspected, while communications associated with initiation of a session are inspected to ensure that the connection is not proscribed by policy. In various implementations of reputation based firewall systems such as, for example, reputation based firewall system 100b, the policies can be based upon reputation information associated with the communications being inspected. For example, the policy can indicate that communications associated with entities having a reputation for originating viruses are to be rejected.

In some implementations, the policy can be context specific, thereby limiting the application of the policy to specific instances. For example, an entity might have a reputation for spreading viruses only by electronic mail. In such examples, the policy might indicate that e-mail associated with the entity is to be rejected, while other traffic associated with the entity should be allowed.

Upon receiving a communication or connection request and determining that the action taken with respect to the communication depends on the reputation of the entities, the firewall processing module 500 can send a request to the reputation retrieval module 510 to retrieve reputation information associated with the communication.

In some implementations, the reputation retrieval module 510 can include a local reputation data store 545. The reputation retrieval module 510 can determine whether the reputation information is included with the local reputation data store 545 and return the reputation information if it is included within the local reputation data store 545. If the reputation information is not included within the local reputation data store 545, in some implementations, the reputation retrieval module 510 can query a reputation server 140 to retrieve the reputation information. The reputation server 140 can retrieve the reputation information from the reputation data store 530 and return the reputation information to the reputation retrieval module 510.

The local reputation data store 545 can include a cache of reputation information. In some implementations, whenever the reputation retrieval module 510 retrieves reputation information from the reputation server, the reputation retrieval module 510 can store the reputation information to the local reputation data store 545. For example, the local reputation data store 545 can include a stack wherein the least recently used reputation information is removed from the stack when a new reputation is retrieved from the reputation server 140.

In other implementations, the reputation retrieval module 510 can periodically download reputation information from the reputation server 140, or the reputation server 140 can push reputation information to the reputation retrieval module 510. In such implementations, the downloaded or pushed reputation information can be a subset of the full set of reputation information can be selected from a full set of reputation information based upon application of a Bloom filter to the full set of reputation information. In other implementations, the reputation information can be a subset of reputation information based upon geolocation of the reputation based firewall system. For example, a firewall in California might be uninterested in reputation information for a server in France. In some implementations, the subset selected can be selected based upon historical communications patters to/from the network in combination with geolocation information.

In some implementations, when the local reputation store 545 does not include reputation information for an entity associated with the received communication, the reputation retrieval module 510 can provide feedback to an administrator 520 or to the reputation server 140. The reputation server 140 or administrator 520 can analyze the communication to determine why the reputation information was not included in the local reputation data store 545. In some implementations, a selection algorithm can be adjusted in response to the analysis. The selection algorithm can be adjusted to provide for inclusion of the reputation information in the reputation update downloaded or pushed to the local reputation data store 545. In other implementations, the reputation retrieval module 510 can store the retrieved reputation information to the reputation data store when reputation information for the entity is retrieved from the reputation server 140.

The reputation information retrieval module 510 can provide reputation information for the entities associated with the communications to the firewall processing module 500. The firewall processing module 500 can apply the policy based on the reputation of the entities associated with the communication.

In some implementations, the policy might indicate to quarantine the communications. The firewall processing module 500 can thereby send communications which policy dictates should be quarantined to the quarantine module 540. In some implementations, the quarantine module 540 implements a dynamic quarantine, whereby communications can be quarantined while additional information is collected which might enable identification of reputation and/or classification of the communication. In other implementations, the quarantine module 540 can provide recipients the opportunity to inspect the communication prior to the communication being rejected by the reputation based firewall system 100b. In still further implementations, the quarantine module 540 can provide an administrator 520 the opportunity to analyze the communication before the communication is rejected by the firewall. In such implementations, the reputation processing module 500 can forward all communications associated with the session to the quarantine module 540. In some implementations, the communication(s) can be released from the quarantine module 540 based upon additional information indicating reputability, a recipient indicating that the communication(s) is(are) legitimate, or an administrator 520 analysis of the communication(s).

FIGS. 5C is a block diagram illustrating another example reputation based firewall system 100c. In some implementations, the reputation based firewall system 100c can include a message classification retrieval module 560 in addition to the reputation processing provided by other implementations. In some implementations, the firewall processing module can query the message classification retrieval module 560 responsive to the reputation of entities associated with the communication. For example, if the reputation of an entity associated with a communication is indeterminate, the firewall processing module 500 can send the communication to the classification retrieval module 560 to classify the communication.

In other implementations, the firewall processing module 500 can send communications to a classification retrieval module 560 when the reputation of a message does not comply with policy. However, before rejecting the communication, the firewall processing module 500 can determine whether the particular communication received has characteristics of the particular type(s) of traffic associated with the entity. For example, if the reputation of an entity associated with the communication indicates that the entity is associated with spam activity and phishing activity, but not with virus activity or other malware activity, the communication can be interrogated to determine whether it includes characteristics of spam or phishing communications.

The message classification retrieval module 560 can query a classification system 570 for the classification of a communication. The classification system 570 can use classification data from the classification data store 580 to classify the communication. Classification of communications is described in U.S. patent application Ser. No. 10/094,266, entitled “Systems And Methods For Anomaly Detection In Patterns Of Monitored Communications,” filed on Mar. 8, 2002, U.S. patent application Ser. No. 11/173,941, entitled “Message Profiling Systems And Methods,” filed on Jul. 1, 2005, and U.S. patent application Ser. No. 12/020,253, entitled “Granular Support Vector Machine with Random Granularity,” filed on Jan. 25, 2008, each of which are hereby incorporated by reference in their entirety. When a classification (e.g., spam, bulk, virus, technical document, legal document, adult content, etc.) associated with the communication is identified, the classification system 570 can return the classification to the classification retrieval module 560. The classification retrieval module 560 can provide the classification of the message to the firewall processing module 500. The firewall processing module 500 can apply policy to the message based upon the classification associated with the message. If a communication is of a classification so that it is allowed by the policy, the firewall processing module 500 can forward the communication to a recipient through protected network 110. In some implementations, if a communication is of a classification so that it is by policy the communication is rejected. In other implementations, if a communication is of a classification so that it is proscribed by policy the communications can be placed in a quarantine. The quarantine, for example, can be a dynamic quarantine that stores the communication while further information is collected by a network of classification systems (e.g., including classification system 570) when the classification of a communication is indeterminate. In other implementations, the quarantine can hold the communication(s) for analysis by an administrator, confirmation of rejection by a recipient, or other analysis.

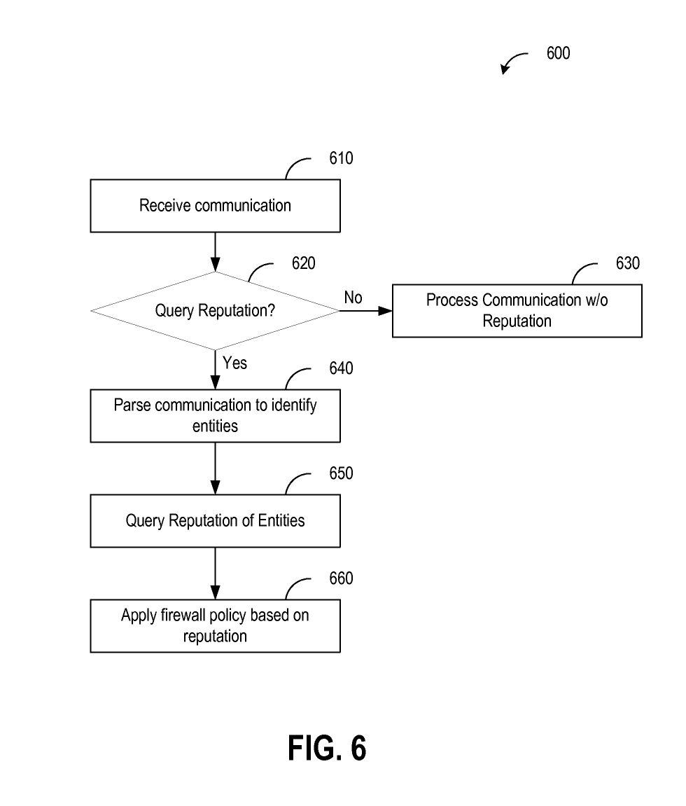

FIG. 6 is a flowchart illustrating an example method 600 for reputation based firewall processing. At stage 610, a communication is received. The communication can be received, for example, by a firewall processing module (e.g., firewall processing module 500 of FIGS. 5A-C). In various implementations, the communication can be any of an electronic message (e.g., simple mail transfer protocol (SMTP) message, post office protocol (POP) message, Internet messaging access protocol (IMAP), etc.), instant message, HTTP communication, file transfer protocol (FTP) communication, simple object access protocol (SOAP) communication, real-time transport protocol (RTP) message, or telnet communication, among many others.

At stage 620, a determination is made whether a reputation should be queried. The determination of whether to query reputation is made, for example, by a firewall processing module (e.g., firewall processing module 500 of FIGS. 5A-C). In some implementations, the determination is made based upon whether the communication is associated with a previously established session. For example, stateful firewalls can inspect packets setting up a communication session, and allow subsequent communications associated with established sessions to pass with minimal interrogation (or without any interrogation). In other implementations, the determination of whether to query reputation is made based upon whether the communication includes indicia of being non-legitimate. For example, if the communication includes a malformed packet based on the protocol, or attempts to connect with a non-standard port, the firewall processing module can determine to query the reputation of entities associated with the communication to determine whether policy proscribes the communication.

If the determination is made that reputation is not to be queried, the communication is processed without reputation, at stage 630. The communication can be processed without reputation, for example, by a firewall processing module (e.g., firewall processing module 500 of FIGS. 5A-C). In some implementations, if a communication is processed without reputation, the firewall processing module can process the communication based upon conventional interrogation.

If the determination is made to query reputation, the communication is parsed to identify entities associated with the communication, at stage 640. The communication can be parsed to identify entities associated with the communication, for example, by a reputation retrieval module (e.g., reputation retrieval module 510 of FIGS. 5A-C) or by a reputation server (e.g., reputation server 140 of FIGS. 5A-C). In some implementations, the entities can include, IP address(es) associated with the communication, media access control (MAC) protocol address(es) associated with the communication, domain name(s) associated with the communication, content associated with the communication, intermediate server(s) associated with the communication, and/or universal resource locator(s) (URL(s)) associated with the communication, among many others.

At stage 650, reputation associated with the entities can be queried. The reputation associated with the entities can be queried, for example, by a reputation retrieval module (e.g., reputation retrieval module 510 of FIGS. 5A-C and local reputation data store 545 of FIG. 5B) or a reputation server (e.g., reputation server 140 of FIGS. 5A-C and reputation data 530 of FIGS. 5A-C). The reputation is retrieved in response to the query. In some implementations, the reputation can be queried from a local reputation data store.

At stage 660, the firewall policy is applied based on the retrieved reputation. The firewall policy can be applied, for example, by a firewall processing module (e.g., firewall processing module 500 of FIGS. 5A-C). In some implementations, the policy can be a reputation based policy. In further implementations, the policy can be based upon both reputation and context.

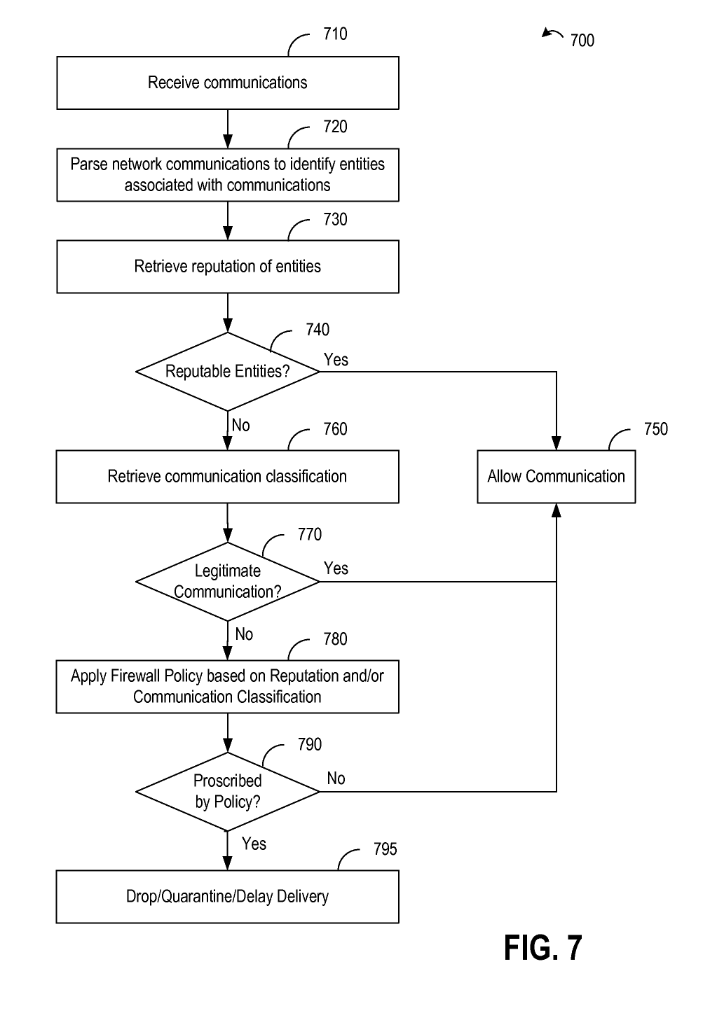

FIG. 7 is a flowchart illustrating another example method 700 for reputation based firewall processing. At stage 710, a communication is received. The communication can be received, for example, by a firewall processing module (e.g., firewall processing module 500 of FIGS. 5A-C). In various implementations, the communication can be any of an electronic message (e.g., simple mail transfer protocol (SMTP) message, post office protocol (POP) message, Internet messaging access protocol (IMAP), etc.), instant message, HTTP communication, file transfer protocol (FTP) communication, simple object access protocol (SOAP) communication, real-time transport protocol (RTP) message, or telnet communication, among many others.

At stage 720, the communication is parsed to identify entities associated with the communication. The communication can be parsed to identify entities associated with the communication, for example, by a reputation retrieval module (e.g., reputation retrieval module 510 of FIGS. 5A-C) or by a reputation server (e.g., reputation server 140 of FIGS. 5A-C). In some implementations, the entities can include, IP address(es) associated with the communication, media access control (MAC) protocol address(es) associated with the communication, domain name(s) associated with the communication, content associated with the communication, intermediate server(s) associated with the communication, and/or universal resource locator(s) (URL(s)) associated with the communication, among many others.

At stage 730, reputation associated with the entities can be retrieved. The reputation associated with the entities can be retrieved, for example, by a reputation retrieval module (e.g., reputation retrieval module 510 of FIGS. 5A-C and local reputation data store 545 of FIG. 5B) or a reputation server (e.g., reputation server 140 of FIGS. 5A-C and reputation data 530 of FIGS. 5A-C). In some implementations, the reputation can be queried from a local reputation data store.

At stage 740, a determination is made whether the entity(ies) are reputable. The determination can be made, for example, by a firewall processing module (e.g., firewall processing module 500 of FIGS. 5A-C).

If the entities associated with the communication is reputable, the communication can be allowed at stage 750. The communication can be allowed, for example, by a firewall processing module (e.g., firewall processing module 500 of FIGS. 5A-C). In some implementations, the communication can be allowed by forwarding the communication to an intended recipient or to an agent operable to deliver the communication to a recipient.

If any of the entities associated with the communication are non-reputable, a classification associated with the communication can be retrieved at stage 760. The classification of the communication can be retrieved, for example, by a classification retrieval module (e.g., classification retrieval module 560 of FIG. 5C). In some implementations, the classification can be retrieved from a classification system 570. The classification system 570 can extract the characteristics of the communication from the communication and use the extracted characteristics to identify a classification associated with the communication.

At stage 770, a determination is made whether the communication is legitimate. The determination of whether the communication is legitimate can be made, for example, by a firewall processing module (e.g., firewall processing module 500 of FIGS. 5A-C). In some implementations, a communication can be classified as legitimate based upon being associated with a legitimate classification.

If the determination is made that the communication is legitimate, the communication can be allowed at stage 750. The communication can be allowed, for example, by a firewall processing module (e.g., firewall processing module 500 of FIG.S 5A-C).

If the determination is made that the communication is not legitimate, a firewall policy can be applied to the communication based upon the reputation and classification of the communication at stage 780. The firewall policy can be applied, for example, by a firewall processing module (e.g., firewall processing module 500 of FIGS. 5A-C). In some implementations, an administrator (e.g., admin 520 of FIGS. 5A-C) can provide policy identifying which communication reputations and/or classifications are legitimate and which are to be proscribed.

At stage 790, a determination is made whether the communication is proscribed by policy. The determination of whether the communication is proscribed can be made, for example, by a firewall processing module (e.g., firewall processing module 500 of FIGS. 5A-C). If the communication is not proscribed by policy, the communication is allowed at stage 750. However, if the communication is proscribed by policy, the communication can be dropped, delayed, quarantined, etc. at stage 795. The communication can be dropped, delayed or quarantined, for example, by a firewall processing module (e.g., firewall processing module 500 of FIGS. 5A-C) or a quarantine (e.g., quarantine module 540 of FIG. 5B).

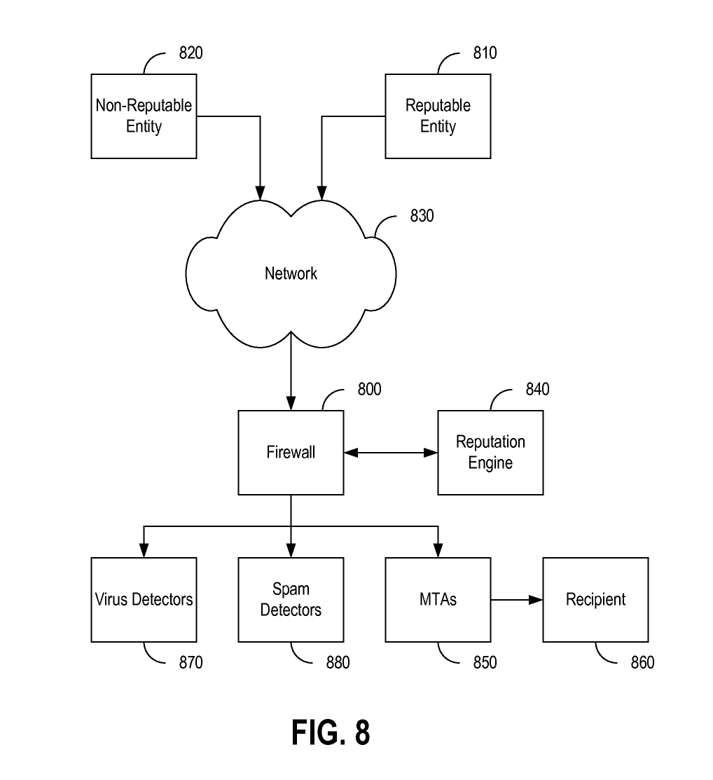

FIG. 8 is a block diagram illustrating an operation of a reputation based firewall 800. The reputation based firewall 800 is operable to receive communications from reputable and non-reputable entities 810, 820 (respectively) through a network 830 (e.g., the Internet). The reputation based firewall 800 communicates with a reputation engine 840 to determine the reputation of entities 810, 820 associated with incoming or outgoing communications.

The reputation engine 840 is operable to provide the reputation based firewall 800 with a reputation vector. The reputation vector can indicate the reputation of the entity 810, 820 associated with the communication in a variety of different categories. For example, the reputation vector might indicate a good reputation for an entity 810, 820 with respect to the entity 810, 820 originating spam, while also indicating a poor reputation for the same entity 810, 820 with respect to that entity 810, 820 originating viruses.

The reputation based firewall 800 can use the reputation vector to determine what action to perform with respect to a communication associated with that entity 810, 820. In situations where a reputable entity 810 is associated with the communication, the message can be sent to a message transfer agent (MTA) 850 and delivered to a recipient 860.

In situations where a non-reputable entity 820 has a reputation for viruses, but does not have a reputation for other types of non-reputable activity, the communication is forwarded to one of a plurality of virus detectors 970. The reputation based firewall 900 is operable to determine which of the plurality of virus detectors 970 to use based upon the current capacity of the virus detectors and the reputation of the originating entity. For example, the reputation firewall 900 could send the communication to the least utilized virus detector. In other examples, the reputation firewall 800 might determine a degree of non-reputability associated with the originating entity and send slightly non-reputable communications to the least utilized virus detectors, while sending highly non-reputable communications to a highly utilized virus detector, thereby throttling the QoS of a connection associated with a highly non-reputable entity.

Similarly, in situations where a non-reputable entity 820 has a reputation for originating spam communications, but no other types of non-reputable activities, the load balancer can send the communication to specialized spam detectors 880 to the exclusion of other types of testing. It should be understood that in situations where a communication is associated with a non-reputable entity 820 that originates multiple types of non-reputable activity, the communication can be sent to be tested for each of the types of non-reputable activity that the entity 820 is known to display, while avoiding tests associated with non-reputable activity that the entity 820 is not known to display.

In some examples, every communication can receive routine testing for multiple types of non-legitimate content. However, when an entity 820 associated with the communication shows a reputation for certain types of activity, the communication can also be quarantined for detailed testing for the content that the entity shows a reputation for originating.

In yet further examples, every communication may receive the same type of testing. However, communications associated with reputable entities 810 is sent to the testing modules with the shortest queue or to testing modules with spare processing capacity. On the other hand, communications associated with non-reputable entities 820 is sent to testing modules 870, 880 with the longest queue. Therefore, communications associated with reputable entities 810 can receive priority in delivery over communications associated with non-reputable entities. Quality of service is therefore maximized for reputable entities 810, while being reduced for non-reputable entities 820. Thus, reputation based load balancing can protect the network from exposure to attack by reducing the ability of a non-reputable entity to connect to the network 830.

Embodiments of the subject matter and the functional operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer program products, i.e., one or more modules of computer program instructions encoded on a tangible program carrier for execution by, or to control the operation of, data processing apparatus. The tangible program carrier can be computer readable medium, such as a machine-readable storage device, a machine-readable storage substrate, a memory device, or a combination of one or more of them.

The terms “computer” or “server” or “data process apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, or declarative or procedural languages, and it can be deployed in any form, including as a stand alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments of the subject matter described in this specification can be implemented in a computing system that includes a back end component, e.g., as a data server, or that includes a middleware component, e.g., an application server, or one that includes a front end component, e.g., a client computer having a graphical user interface or a Web browser through which a user can interact with an implementation of the subject matter described is this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Particular embodiments of the subject matter described in this specification have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

What is claimed is:

1. A reputation based firewall system, comprising:
a firewall processing module operable to receive a data packet directed to a protected network and to permit or deny the data packet entry to the protected network based upon a firewall policy associated with the protected network, the firewall policy comprising at least one rule based upon a reputation of an external entity associated with the data packet; and
a reputation retrieval module operable to retrieve reputation information for the external entity associated with the data packet and to provide the reputation information to the firewall processing module based upon identification of the reputation information for external entity.

2. The system of claim 1, further comprising a classification retrieval module operable to retrieve a classification of the data packet, the classification being based upon characteristics of the data packet.

3. The system of claim 1, wherein the reputation retrieval module is operable to access a local reputation data store operable to store and delete reputation information for a selected subset of entities.

4. The system of claim 3, wherein the selected subset of entities is selected based upon application of a geolocation of the reputation based firewall system.

5. The system of claim 3, wherein the selected subset of entities is selected based upon a deletion of least recently used reputation information if the local reputation data store is full and reputation information associated with an entity not included in the selected subset is requested, wherein the reputation information associated with the entity not included in the selected subset is retrieved from a reputation server and stored to the local reputation data store.

6. The system of claim 1, further comprising a quarantine module operable to store data packets denied entry to the protected network.

7. The system of claim 6, wherein the quarantine module implements a dynamic quarantine to store the data packets for a period of time while further reputation data is collected by a reputation system, and to resubmit the data packets to the firewall processing module after the period of time.

8. The system of claim 1, wherein the reputation information comprises an aggregation of reputation information associated with the entity from more than one reputation engine.

9. A computer-implemented method, comprising:
receiving a communication at a data processing apparatus;
parsing, at the data processing apparatus, the communication to identify entities associated with the communication;
retrieving, at the data processing apparatus, reputation information for the entities;
applying, at the data processing apparatus, a firewall policy to the communication based upon the retrieved reputation information associated with the entities; and
processing, at the data processing apparatus, the communication responsive to applying the firewall policy.

10. The method of claim 9, further comprising:
in response to determining that the firewall policy indicates that communications for an entity associated with the communication are proscribed, quarantining the communication and retrieving a classification associated with the communication, the classification being based upon characteristics of the communication; and
applying a firewall policy to the communication based upon retrieved classification of the data packets.

11. The method of claim 9, further comprising:
caching reputation information associated with a selected subset of entities on a local reputation data store accessible by the data processing apparatus;
wherein retrieving reputation information comprises:
attempting to retrieve reputation information from the local reputation data store; and
retrieving reputation information from a reputation server if the attempt to retrieve reputation information from the local reputation data store fails.

12. The method of claim 11, wherein the selected subset of entities is selected based upon application of a geolocation of the reputation based firewall system.

13. The method of claim 9, further comprising:
caching reputation information associated with a subset of entities;
determining whether the cache includes reputation information for an entity associated with the communication;
if the cache does not include reputation information for an entity associated with the communication:
retrieving reputation information from a reputation server; and
determining whether the cache is full;
if the cache is full:
identifying least recently used reputation information;
deleting the least recently used reputation information; and
storing the retrieved reputation information in the cache.

14. The method of claim 9, wherein processing communications comprises:
dynamically quarantining the communication for a period of time when the reputation information is indeterminate;
retrieving updated reputation information for entities associated with the communication;
reapplying the firewall policy to the communication based upon the updated reputation information associated with the entities after the period of time; and
processing the communication responsive to reapplying the firewall policy.

15. The method of claim 9, wherein the reputation information comprises an aggregation of reputation information for entities associated with the communications from more than one reputation engine.

16. The method of claim 9, further comprising determining that the communication is part of a previously established session and in response allowing the communication without parsing the communication, retrieving reputation information, or applying the firewall policy.

17. The method of claim 16, wherein the communication is a data packet.
